(19) United States
(12) Patent Application Publication
(10) Pub. No.: US 2013/0118311 A1
(43) Pub. Date: May 16, 2013

(54) Hybrid Scissors or Forceps and Method of Manufacturing Hybrid Scissors or Forceps

(71) Applicants: Bradley BENDER, Lincoln, RI (US); Michael SCHULER, Princeton, NJ (US); Jeffrey I. LASNER, Purchase, NY (US)

(72) Inventors: Bradley BENDER, Lincoln, RI (US); Michael SCHULER, Princeton, NJ (US); Jeffrey I. LASNER, Purchase, NY (US)

(73) Assignee: TRI-MEDICS, Foxboro, MA (US)

(21) Appl. No.: 13/489,331

(22) Filed: Jun. 5, 2012

Related U.S. Application Data
(60) Provisional application No. 61/629,143, filed on Nov. 14, 2011.
(60) Provisional application No. 61/634,087, filed on Feb. 23, 2012.

(51) Int. Cl. B25G 1/02; B23P 11/00; B25B 7/02; B25B 7/00; B26B 13/00; B26B 13/28

(52) U.S. Cl. 76/104.1; 81/489; 81/427.5; 30/165; 30/254; 81/415; 76/119

(57) ABSTRACT

A device, and a method of making the device, having a blank having a rigid handle at a proximal end and a flexible operative end at a distal end are described. The rigid handle and the flexible operative end are joined to each other such that the flexible operative end is configured to be in an arced position when at rest and unopposed, and to resiliently flex to a substantially straight position when opposed. The rigid handle and the flexible operative end may be joined to each other between a pivot point and a proximal end of the device. The device may form hybrid scissors or hybrid forceps.

### CROSS-REFERENCE TO RELATED APPLICATIONS

The present application claims the benefit of U.S. Provisional Patent Application No. 61/629,143, filed on Nov. 14, 2011, and U.S. Provisional Patent Application No. 61/634,087, filed on Feb. 21, 2012, each of which is expressly incorporated herein in its entirety by reference thereto.

### FIELD OF THE INVENTION

The present invention relates to hybrid scissors or forceps, and to a method of manufacturing hybrid scissors or forceps.

### BACKGROUND INFORMATION

U.S. Pat. Nos. 4,527,331; 6,592,603; and 7,497,867 describe the use of materials, manufacture and cutting efficiencies for improved scissors or forceps devices over conventional self-opening or automatic return scissors or forceps devices.

### SUMMARY

Exemplary embodiments of the present invention provide hybrid scissors or forceps, and a method of manufacturing the hybrid scissors or forceps.

According to an exemplary embodiment of the present invention, a device includes a blank having a rigid handle at a proximal end and a flexible operative end at a distal end. The rigid handle and the flexible operative end are joined to each other such that the flexible operative end is configured to be in an arced position when at rest and unopposed, and to resiliently flex to a substantially straight position when opposed.

Two blanks may be pivotally connected at a pivot point between the proximal end and the distal end, and the rigid handle and the flexible operative end may be joined to each other between the pivot point and the proximal end. The flexible operative ends of each of the two blanks may have different degrees of flexibility. The pivot point may include at least one of a scrivet, a rivet, a screw, and a pin. The flexible operative end may be configured to be twisted relative to the rigid handle, and may include at least one of a cutting blade and a grasping arm. The rigid handle may include a locking device configured to maintain the device in a closed position.

According to an exemplary embodiment of the present invention, a device includes: a first component formed of a blank having a rigid handle and a flexible operative end; and a second component formed of a blank having a rigid handle and a flexible operative end, the first component and the second component pivotally coupled together. The rigid handle and the flexible operative end of each of the first and second components are joined to each other such that the flexible operative end is configured to be in an arced position when at rest and unopposed, and to resiliently flex to a substantially straight position when opposed. The device thus forms a hybrid scissors and/or a hybrid forceps.

According to an exemplary embodiment of the present invention, a method of making a device that includes at least one blank having a rigid handle and a flexible operative end, includes joining the rigid handle and the flexible operative end such that the flexible operative end is in an arced position when at rest and unopposed, and resiliently flexes to a substantially straight position when opposed.

The method may further include pivotally joining a first blank to a second blank at a pivot point, and the rigid handle and the flexible operative end may be joined to each other between the pivot point and a proximal end of the device. The flexible operative ends of each of the first and second blanks may have different degrees of flexibility. The pivot point may include at least one of a scrivet, a rivet, a screw, and a pin. The method may further include twisting the flexible operative end relative to the rigid handle. The method may further include forming at least one of a cutting blade and a grasping arm in the flexible operative end.

According to an exemplary embodiment of the present invention, hybrid scissors may include flexible blades configured to arc across each other in an open position of the scissors, the blades being configured to resiliently flex and align in a common plane with each other in a closed position of the scissors; and rigid handles having attachment ends and free ends, the attachment ends joined to the flexible blades and the free ends configured to be unconstrained.

According to an exemplary embodiment of the present invention, hybrid forceps may include flexible grasping arms configured to arc across each other in an open position of the forceps, the grasping arms being configured to resiliently flex and align in a common plane with each other in a closed position of the forceps; and rigid handles having attachment ends and free ends, the attachment ends joined to the flexible grasping arms and the free ends configured to be unconstrained.

Other features and aspects of example embodiments of the present invention are described in more detail below with reference to the appended Figures.

### BRIEF DESCRIPTION OF THE DRAWINGS

FIG. 1 illustrates a schematic plan view of a device according to a first exemplary embodiment of the present invention.

FIG. 2 illustrates a schematic plan view of a device according to a second exemplary embodiment of the present invention.

FIG. 3 illustrates a schematic flow diagram of a method of making a device according to an exemplary embodiment of the present invention.

### DETAILED DESCRIPTION

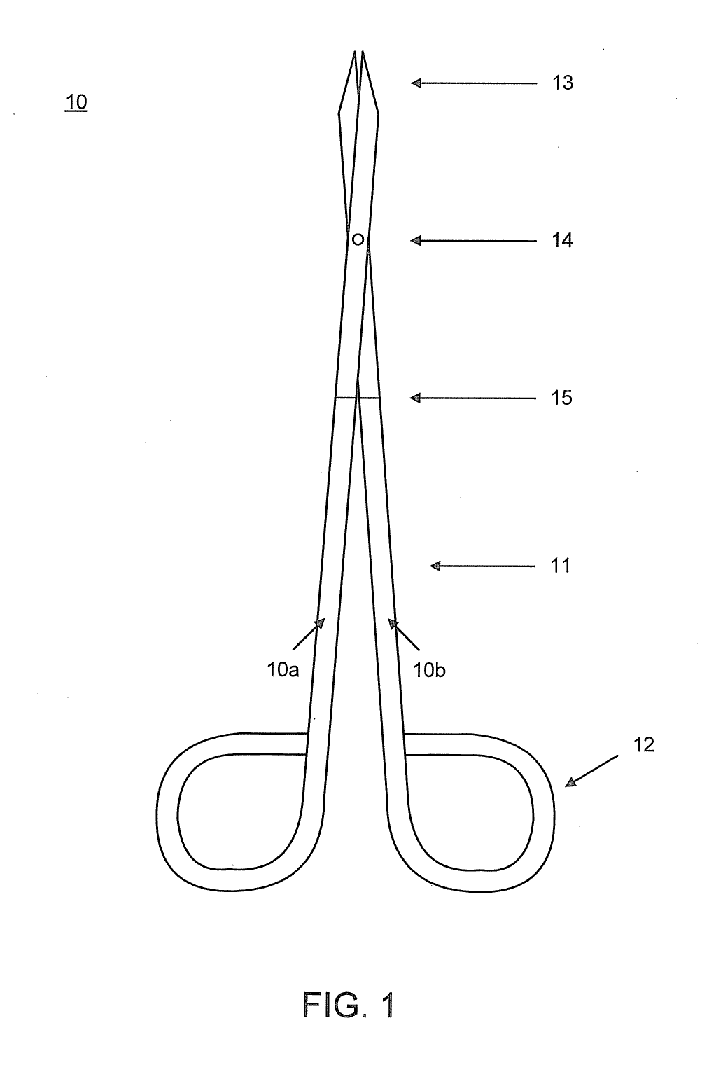

FIG. 1 schematically illustrates a device 10 according to a first exemplary embodiment of the present invention. FIG. 1 schematically illustrates a hybrid scissors or a hybrid forceps.

The device 10 includes a rigid handle 11 at a proximal end of the device 10. The rigid handle 11 may include ring handles 12. Alternatively, other types of handles may be provided, such as straight, arced, angled, or other suitable configurations. The rigid handle 11 is made of a material that remains rigid during use, i.e., the handle 11 is not resiliently flexible during use of the device 10. For example, the rigid handle 11 may be formed of hardened steel.

The device 10 also includes a flexible operative end 13 at a distal end of the device 10. The flexible operative end 13 may include a cutting blade and/or a grasping arm. In addition, the flexible operative end 13 may be straight, curved, and/or angled. For example, the flexible operative end 13 may be angled at 45°, e.g., a Potts 45° operative end. The flexible operative end 13 may be twisted, for example, approximately 90° about a longitudinal axis of the device 10, relative to the rigid handle 11. The flexible operative end 13 is made of a material that resiliently flexes during use, for example, 300 series spring steel. The flexible operative end 13 may be made from flexibly resilient, medical grade materials having any or all the features described in U.S. Pat. Nos. 4,527,331; 6,592,603; and 7,497,867, which are expressly incorporated herein in their entireties by reference thereto. The flexible operative end 13 is configured to be in an arced position when at rest and unopposed, and to resiliently flex to a substantially straight position when opposed. The device 10, as shown in FIG. 1, includes two blanks 10a, 10b, each having a rigid handle 11 and a flexible operative end 13. The rigid handle 11 and flexible operative end 13 of each blank 10a, 10b are joined at an interface 15. Although FIG. 1 schematically illustrates the interface 15 as a line, the interface 15 may alternatively be a region, portion, or section of different configuration and/or indeterminate length between the rigid handle 11 and flexible operative end 13. Further, the location of the interface 15 between the distal and proximal ends of the device 10 may be determined based on the desired cutting force or grasping pressure to be applied at the flexible operative end 13, as well as based on the particular materials used for each of the rigid handle 11 and flexible operative end 13. By the joining of the rigid handle 11 and flexible operative end 13 at the interface 15 of each blank 10a, 10b, the flexible operative end 13 is configured to resiliently flex during use while the rigid handle 11 does not resiliently flex.

As shown in FIG. 1, two blanks 10a, 10b are pivotally connected at a pivot point 14 between the proximal and distal ends of the device 10. The pivot point 14 may include a scrivet, a rivet, a screw, and/or a pin. In this context, a scrivet refers to a partially threaded screw that is screwed into the pivot point 14 and then welded in position such that relative pivotal movement between the two blanks 10a, 10b is maintained. The pivot point 14 may be countersunk to accommodate any of the scrivet, rivet, screw and/or pin. The rigid handle 11 and flexible operative end 13 of each blank 10a, 10b may be joined at an interface 15 that is situated between the pivot point 14 and a proximal end of the device 10.

Alternatively, each of the two blanks 10a, 10b may have a flexible operative end 13, in which the flexibility of the end 13 of one blank 10a is different from the flexibility of the end 13 of the other blank 10b. For example, in a most extreme embodiment, the end 13 of one blank 10a may be flexible to resiliently flex during use, whereas the end 13 of the other blank 10b may be relatively inflexible, e.g., rigid. Accordingly, the flexible operative end 13 of the one blank 10a may be configured to arc across the relatively inflexible operative end 13 of the other blank 10b in an open position of the device.

By the use of blanks 10a, 10b that have flexible operative ends 13 and rigid handles 11, the device 10 may be self-calibrating and pressure-limiting because the flexible operative ends 13 resiliently flex during use. In addition, the flexible operative ends 13 may be designed with thin profiles such that distal visibility during use of the device 10 is increased. Simultaneously, the rigid handles 11 may provide a comfortable and secure grip for the user. Further, by appropriate selection of the materials for the rigid handles 11 and flexible operative ends 13 and appropriate location of the interface 15 therebetween, the weight, balance, and durability of the device 10 may be improved, thereby enhancing user manipulation of the device 10 during medical procedures.

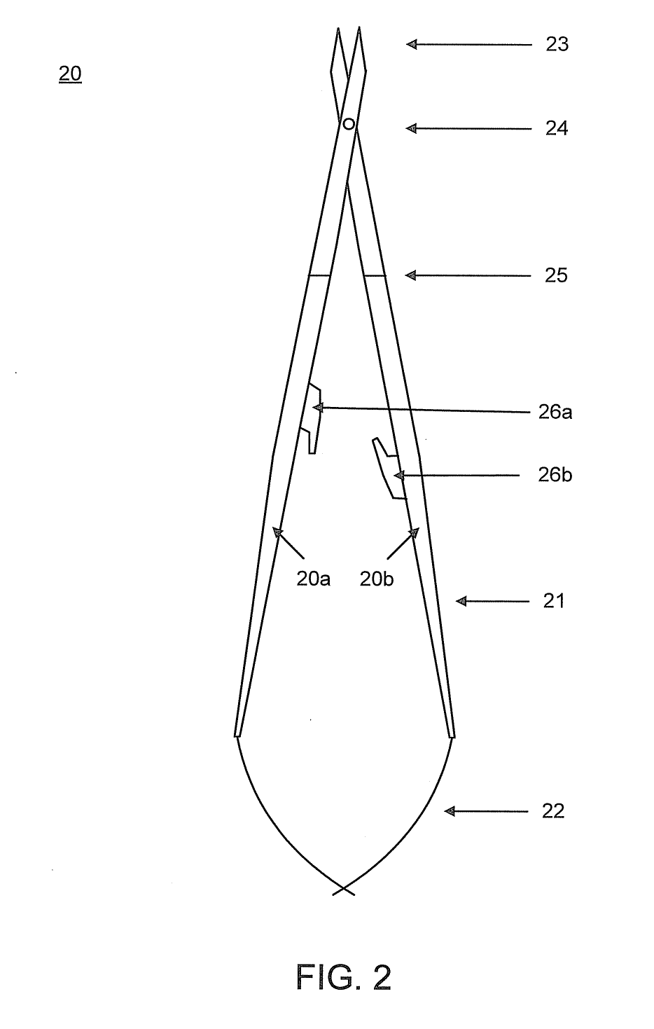

FIG. 2 schematically illustrates a device 20 according to a second exemplary embodiment of the present invention. FIG. 2 schematically illustrates a hybrid scissors or a hybrid forceps.

The device 20 includes a rigid handle 21 at a proximal end of the device 20. The rigid handle 21 may include straight handles connected to each other by springs 22. Alternatively, other types of handles may be provided, such as arced, angled, or other suitable configurations. The rigid handle 21 is made of a material that remains rigid during use, i.e., the handle 21 is not resiliently flexible during use of the device 20. For example, the rigid handle 21 may be formed of hardened steel. The springs 22 may be formed of a resiliently flexible material, for example, 300 series spring steel, such that the rigid handles 21 are biased towards a normally open position, as shown in FIG. 2.

In addition, the rigid handles 21 may include cooperating locking elements 26a, 26b that function similar to a ratcheting mechanism. For example, the locking elements 26a, 26b may be configured to lock the device 20 in a closed position when the rigid handles 21 are pushed toward each other such that the locking elements 26a, 26b engage with each other. In order to unlock the device 20, the rigid handles 21 may be pushed further toward each other, thereby disengaging the locking elements 26a, 26b from each other so that the device 20 returns to an open position. In particular, upon movement of the rigid handles 21 toward each other, one locking element 26a may include a detent or groove in which the other locking element 26b is held, against the opening force of the springs 22, thereby locking the device 20 in a closed position. Upon further movement of the rigid handles 21 toward each other, the locking element 26b may become disengaged from the detent or groove of the locking element 26a so that the device 20 may return to an open position under the opening force of the springs 22.

The device 20 also includes a flexible operative end 23 at a distal end of the device 20. The flexible operative end 23 may include a cutting blade and/or a grasping arm. In addition, the flexible operative end 23 may be straight, curved, and/or angled. For example, the flexible operative end 23 may be angled at 45°, e.g., a Potts 45° operative end. The flexible operative end 23 may be twisted, for example, approximately 90° about a longitudinal axis of the device 20, relative to the rigid handle 21. The flexible operative end 23 is made of a material that resiliently flexes during use, for example, 300 series spring steel. The flexible operative end 23 may be made from flexibly resilient, medical grade materials having any or all the features described in U.S. Pat. Nos. 4,527,331; 6,592,603; and 7,497,867, which are expressly incorporated herein in their entireties by reference thereto. The flexible operative end 23 is configured to be in an arced position when at rest and unopposed, and to resiliently flex to a substantially straight position when opposed.

The device 20, as shown in FIG. 2, includes two blanks 20a, 20b, each having a rigid handle 21 and a flexible operative end 23. The rigid handle 21 and flexible operative end 23 of each blank 20a, 20b are joined at an interface 25. Although FIG. 2 schematically illustrates the interface 25 as a line, the interface 25 may alternatively be a region, portion, or section of different configuration and/or indeterminate length between the rigid handle 21 and flexible operative end 23. Further, the location of the interface 25 between the distal and proximal ends of the device 20 may be determined based on the desired cutting force or grasping pressure to be applied at the flexible operative end 23, as well as based on the particular materials used for each of the rigid handle 21 and flexible operative end 23. By the joining of the rigid handle 21 and flexible operative end 23 at the interface 25 of each blank 20a, 20b, the flexible operative end 23 is configured to resiliently flex during use while the rigid handle 21 does not resiliently flex.

As shown in FIG. 2, two blanks 20a, 20b are pivotally connected at a pivot point 24 between the proximal and distal ends of the device 20. The pivot point 24 may include a scrivet, a rivet, a screw, and/or a pin. In this context, a scrivet refers to a partially threaded screw that is screwed into the pivot point 24 and then welded in position such that relative pivotal movement between the two blanks 20a, 20b is maintained. The pivot point 24 may be countersunk to accommodate any of the scrivet, rivet, screw and/or pin. The rigid handle 21 and flexible operative end 23 of each blank 20a, 20b may be joined at an interface 25 that is situated between the pivot point 24 and a proximal end of the device 20.

Alternatively, each of the two blanks 20a, 20b may have a flexible operative end 23, in which the flexibility of the end 23 of one blank 20a is different from the flexibility of the end 23 of the other blank 20b. For example, in a most extreme embodiment, the end 23 of one blank 20a may be flexible to resiliently flex during use, whereas the end 23 of the other blank 20b may be relatively inflexible, e.g., rigid. Accordingly, the flexible operative end 23 of the one blank 20a may be configured to arc across the relatively inflexible operative end 23 of the other blank 20b in an open position of the device.

By the use of blanks 20a, 20b that have flexible operative ends 23 and rigid handles 21, the device 20 may be self-calibrating and pressure-limiting because the flexible operative ends 23 resiliently flex during use. In addition, the flexible operative ends 23 may be designed with thin profiles such that distal visibility during use of the device 20 is increased. Simultaneously, the rigid handles 21 may provide a comfortable and secure grip for the user. Further, by appropriate selection of the materials for the rigid handles 21 and flexible operative ends 23 and appropriate location of the interface 25 therebetween, the weight, balance, and durability of the device 20 may be improved, thereby enhancing user manipulation of the device 20 during medical procedures.

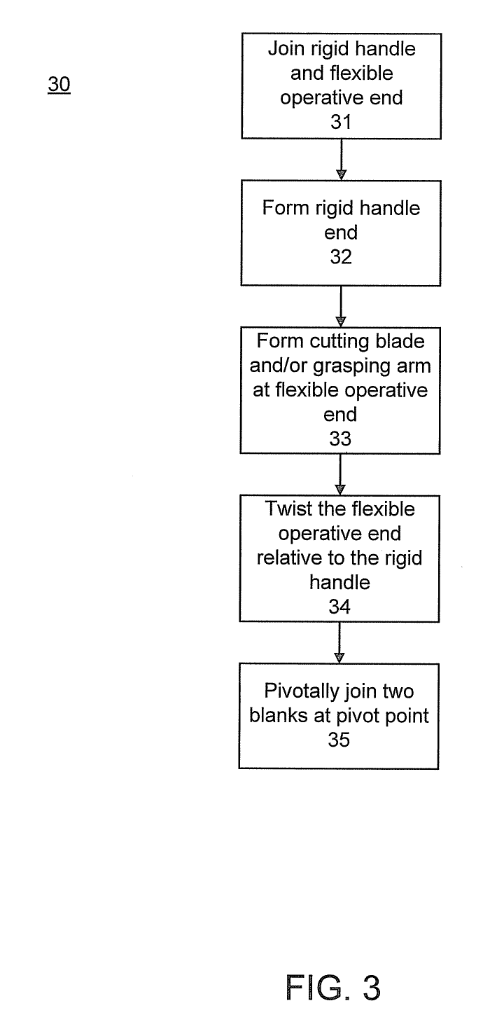

FIG. 3 schematically illustrates a method 30 of making a device 10, 20 according to an exemplary embodiment of the present invention.

At step 31, a rigid handle 11, 21 and a flexible operative end 13, 23 are joined at an interface 15, 25. The interface 15, 25 may be a region, portion, or section of different configuration and/or indeterminate length between the rigid handle 11, 21 and flexible operative end 13, 23. Further, the location of the interface 15, 25 between the distal and proximal ends of the device 10, 20 may be determined based on the desired cutting force or grasping pressure to be applied at the flexible operative end 13, 23, as well as based on the particular materials used for each of the rigid handle 11, 21 and flexible operative end 13, 23. By the joining of the rigid handle 11, 21 and flexible operative end 13, 23 at the interface 15, 25 of each blank 10a, 10b, 20a, 20b, the flexible operative end 13, 23 is configured to resiliently flex during use while the rigid handle 11, 21 does not resiliently flex. The rigid handle 11, 21 and the flexible operative end 13, 23 may be joined by welding, laser welding, bonding material, and/or a friction fit, such as a male-female friction fit.

At step 32, the rigid handle 11, 21 may be formed. For example, the rigid handle 11, 21 may be ring, straight, arced, angled, or other suitable handle configurations. In addition, springs 22 may connect the rigid handles 21 of blanks 20a, 20b to each other, such that the rigid handles 21 are biased towards a normally open position.

At step 33, the flexible operative end 13, 23 may be formed. For example, the flexible operative end 13, 23 may include a cutting blade and/or a grasping arm. In addition, the flexible operative end 13, 23 may be straight, curved, and/or angled. For example, the flexible operative end 13, 23 may be angled at 45°, e.g., a Potts 45° operative end.

At step 34, the flexible operative end 13, 23 may be twisted relative to the rigid handle 11, 21. For example, the flexible operative end 13, 23 may be twisted approximately 90° about a longitudinal axis of the device 10, 20, relative to the rigid handle 11, 21. The twist may be formed at any location between the proximal and distal ends of the device 10, 20. In addition, more than one twist may be formed in the device 10, 20.

At step 35, two blanks 10a, 10b or 20a, 20b are pivotally connected to each other at a pivot point 14, 24 between the proximal and distal ends of the device 10, 20, thereby forming a hybrid scissors or a hybrid forceps. The pivot point 14, 24 may include a scrivet, a rivet, a screw, and/or a pin. In this context, a scrivet refers to a partially threaded screw that is screwed into the pivot point 14, 24 and then welded in position such that relative pivotal movement between the two blanks 10a, 10b, 20a, 20b is maintained. The pivot point 14, 24 may be countersunk to accommodate any of the scrivet, rivet, screw and/or pin. The rigid handle 11, 21 and flexible operative end 13, 23 of each blank 10a, 10b, 20a, 20b may be joined at an interface 15, 25 that is situated between the pivot point 14, 24 and a proximal end of the device 10, 20.

Although steps 31 to 35 are schematically shown in FIG. 3 in a particular order, the order of steps 31 to 35 may alternatively be rearranged. That is, steps 31 to 35 may be performed in any order to manufacture the device 10, 20. For example, the forming of the rigid handles 11, 21 and flexible operative ends 13, 23 and the relative twisting between the rigid handles 11, 21 and flexible operative ends 13, 23 may be performed before joining the rigid handles 11, 21 and flexible operative ends 13, 23 at interface 15, 25. In addition, step 34 may optionally be omitted. Further, step 35 may preferably be performed after steps 31 to 34.

Hybrid scissors according to the present invention may include flexible blades configured to arc across each other in an open position of the scissors, the blades being configured to resiliently flex and align in a common plane with each other in a closed position of the scissors; and rigid handles having attachment ends and free ends, the attachment ends joined to the flexible blades and the free ends configured to be unconstrained.

Hybrid forceps according to the present invention may include flexible grasping arms configured to arc across each other in an open position of the forceps, the grasping arms being configured to resiliently flex and align in a common plane with each other in a closed position of the forceps; and rigid handles having attachment ends and free ends, the attachment ends joined to the flexible grasping arms and the free ends configured to be unconstrained.

In addition to the above described exemplary embodiments, other useful devices may also be manufactured according to the exemplary method of the present invention. Further, although the above described embodiments have been shown with a particular shape, size, and other features, the above embodiments are described by way of example only.

It is apparent that many modifications and variations of this invention as hereinabove set forth may be made without departing from the spirit and scope hereof. The specific embodiments described are given by way of example only, and the invention is limited only by the terms of the appended claims.

What is claimed is:

1. A device, comprising:
a blank having a rigid handle at a proximal end and a flexible operative end at a distal end;
wherein the rigid handle and the flexible operative end are joined to each other such that the flexible operative end is configured to be in an arced position when at rest and unopposed, and to resiliently flex to a substantially straight position when opposed.

2. The device according to claim 1, wherein the rigid handle and the flexible operative end are joined by at least one of welding, laser welding, bonding material, a friction fit, and a male-female friction fit.

3. The device according to claim 1, wherein two blanks are pivotally connected at a pivot point between the proximal end and the distal end.

4. The device according to claim 3, wherein the rigid handle and the flexible operative end are joined to each other between the pivot point and the proximal end.

5. The device according to claim 3, wherein the pivot point includes at least one of a scrivet, a rivet, a screw, and a pin.

6. The device according to claim 3, wherein the flexible operative ends of each of the two blanks have different degrees of flexibility.

7. The device according to claim 1, wherein the flexible operative end is configured to be twisted relative to the rigid handle.

8. The device according to claim 1, wherein the flexible operative end includes at least one of a cutting blade and a grasping arm.

9. The device according to claim 1, wherein the rigid handle includes a locking device configured to maintain the device in a closed position.

10. A device, comprising:
a first component formed of a blank having a rigid handle and a flexible operative end;
a second component formed of a blank having a rigid handle and a flexible operative end, the first component and the second component pivotally coupled together;
wherein the rigid handle and the flexible operative end of each of the first and second components are joined to each other such that the flexible operative end is configured to be in an arced position when at rest and unopposed, and to resiliently flex to a substantially straight position when opposed;
the device forming at least one of a hybrid scissors and a hybrid forceps.

11. A method of making a device including at least one blank having a rigid handle and a flexible operative end, comprising:
joining the rigid handle and the flexible operative end such that the flexible operative end is in an arced position when at rest and unopposed, and resiliently flexes to a substantially straight position when opposed.

12. The method according to claim 11, wherein the rigid handle and the flexible operative end are joined by at least one of welding, laser welding, bonding material, a friction fit, and a male-female friction fit.

13. The method according to claim 11, further comprising pivotally joining a first blank to a second blank at a pivot point.

14. The method according to claim 13, wherein the rigid handle and the flexible operative end are joined to each other between the pivot point and a proximal end of the device.

15. The method according to claim 13, wherein the pivot point includes at least one of a scrivet, a rivet, a screw, and a pin.

16. The method according to claim 13, wherein the flexible operative ends of each of the first and second blanks have different degrees of flexibility.

17. The method according to claim 11, further comprising twisting the flexible operative end relative to the rigid handle.

18. The method according to claim 11, further comprising forming at least one of a cutting blade and a grasping arm in the flexible operative end.

19. Hybrid scissors, comprising:
flexible blades configured to arc across each other in an open position of the scissors, the blades being configured to resiliently flex and align in a common plane with each other in a closed position of the scissors; and
rigid handles having attachment ends and free ends, the attachment ends joined to the flexible blades and the free ends configured to be unconstrained.

20. Hybrid forceps, comprising:
flexible grasping arms configured to arc across each other in an open position of the forceps, the grasping arms being configured to resiliently flex and align in a common plane with each other in a closed position of the forceps; and
rigid handles having attachment ends and free ends, the attachment ends joined to the flexible grasping arms and the free ends configured to be unconstrained.
